(19) United States
(12) Patent Application Publication
(10) Pub. No.: US 2006/0099385 A1
(43) Pub. Date: May 11, 2006

(54) Material for forming antiglare hard coat layer and antiglare hard coat film

(75) Inventors: Yutaka Onozawa, Kawagoe-shi (JP); Satoru Shoshi, Koshigaya-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: LINTEC CORPORATION, Tokyo (JP)

(21) Appl. No.: 11/256,265

(22) Filed: Oct. 20, 2005

(30) Foreign Application Priority Data
Nov. 11, 2004 (JP) 2004-327987

(51) Int. Cl. B32B 27/40; B32B 27/36; B32B 27/30; B32B 27/00

(52) U.S. Cl. 428/141; 428/411.1; 428/480; 428/423.1; 428/522; 428/336; 522/113; 522/134

(57) ABSTRACT

A material for forming an antiglare hard coat layer which comprises (A) a polymerizable compound of an active energy beam curing type, (B) a thermoplastic resin, (C) a good solvent for (A) and (B), and (D) a poor solvent for (B), wherein the ratio of amounts by weight of (A) to (B) is 100:0.3 to 100:50 and the ratio of amounts by weight of (C) to (D) is 99:1 to 30:70; and an antiglare hard coat film which comprises an antiglare hard coat layer comprising a layer of an active energy beam-cured resin formed by using the above material and disposed on a substrate film. The hard coat film contains no fine particles or a decreased amount of fine particles for providing the antiglare property and exhibits highly fine antiglare property, stable optical properties and excellent scratch resistance.

### BACKGROUND OF THE INVENTION

1. Field of the Invention

The present invention relates to a material for forming an antiglare hard coat layer and an antiglare hard coat film. More particularly, the present invention relates to a coating material which can form an antiglare hard coat layer containing no fine particles or a decreased amount of fine particles for providing the antiglare property and exhibiting highly fine antiglare property, stable optical properties and excellent scratch resistance, and to an antiglare hard coat film obtained by using the coating material and advantageously used for various displays.

2. Description of Related Art

When a display device such as CRT and liquid crystal displays is used, light from the outside is occasionally reflected at the surface of the display (so-called glare) and difficulty arises in watching images on the display. In particular, as the size of flat panel displays increases recently, solving the above problem is becoming more important.

To overcome the above problem, various methods for preventing glare have been used for various types of display. As an example of such methods for preventing glare, roughness is formed on the surface of hard coat films used for polarizing films in liquid crystal displays and protective hard coat films for various types of display. The antiglare methods for hard coat films can generally be divided into (1) methods in which roughness is formed on the surface of a hard coat film by a physical means during curing for forming a hard coat layer and (2) methods in which a filler is mixed into a hard coat material which is used for forming a hard coat layer.

Between these two types of method, the latter methods in which a filler is mixed into a hard coat material is mainly used, and silica particles are mainly used as the filler. Silica particles are used because whiteness of the obtained hard coat film can be kept low, and the decrease in the hardness can be suppressed.

However, when conventional silica particles are used, it is difficult that the silica particles are uniformly dispersed in the coating material. Silica particles precipitate or aggregate, and it is difficult that a stable antiglare hard coat layer is formed.

Displays are recently becoming highly fine so that images of a high quality can be obtained, and the conventional antiglare methods for hard coat films cannot satisfy the recent requirements. Although various methods such as introduction of aggregates of particles of colloidal silica into a hard coat layer have been attempted (for example, Patent reference 1), further improvement in the clarity is desired.

A scratch resistant antiglare film in which an antiglare layer composed of resin beads having a refractive index of 1.40 to 1.60 and a resin composition of the ionizing radiation curing type is disposed on a transparent substrate film is proposed (for example, Patent reference 2). In this antiglare film, polymethyl methacrylate beads, polycarbonate beads, polystyrene beads, polyacryl styrene beads and polyvinyl chloride beads having a particle diameter in the range of 3 to 8 μm are used as the preferable resin beads. To prevent precipitation of the resin beads in the coating material, silica beads having a particle diameter of 0.5 μm or smaller are added in an amount less than about 0.1 parts by weight per 100 parts by weight of the resin of the ionizing radiation curing type.

In this technology, silica beads having a small particle diameter are added to prevent precipitation of the resin beads. However, a problem arises in that the dispersion of the resin beads is not always satisfactory, and it is difficult that a stable antiglare hard coat layer is formed.

When a hard coat material containing filler particles is used as described above, a problem inevitably arises in that an increase in the amount of the filler particles to obtain a more excellent antiglare property causes a decrease in the hardness (the scratch resistance) of the formed hard coat layer. A highly fine antiglare hard coat layer can be formed by using filler particles having small diameters. However, the use of the filler particles having small diameters causes a problem in that aggregation of the filler particles tends to take place, and it is difficult that a stable highly fine antiglare hard coat layer is formed.

As the technology for forming an antiglare layer without using filler particles, a technology in which a phase separation structure is formed from a liquid phase containing at least one polymer, at least one precursor for a curable resin and a solvent by the spinodal decomposition accompanied with vaporization of the solvent, and an antiglare layer having rough structure on the surface is formed by curing the precursor for a curable resin, is disclosed (for example, Patent reference 3).

In the above technology, it is described that any solvent can be used as long as the solvent can uniformly dissolve the components. No descriptions can be found on the solubility of the components in separated phases. A problem arises in that regions formed by the phase separation grow excessively, and the highly fine antiglare function is occasionally not exhibited depending on the type of the solvent employed.

[Patent reference 1] Japanese Patent Application Laid-Open No. Heisei 10(1998)-180950

[Patent reference 2] Japanese Patent Application Laid-Open No. Heisei 6(1994)-18706

[Patent reference 3] Japanese Patent Application Laid-Open No. 2004-126495

### BRIEF SUMMARY OF THE INVENTION

Under the above circumstance, the present invention has an object of providing a coating material which can form an antiglare hard coat layer containing no fine particles or a decreased amount of fine particles for providing the antiglare property and exhibiting highly fine antiglare property, stable optical properties and excellent scratch resistance, and an antiglare hard coat film obtained by using the coating material and advantageously used for various displays.

As the result of intensive studies by the present inventors on the coating material exhibiting the above advantageous properties, it was found that, when a coating material comprised a polymerizable compound of an active energy beam curing type and a thermoplastic resin in specific relative amounts and at least two types of solvents, and the solvents were used as a mixed solvent comprising a good solvent for both of the polymerizable compound of an active energy beam curing type and the thermoplastic resin and a poor solvent for the thermoplastic resin in specific relative amounts, fine phase separation took place and an uncured layer having a fine rough structure was formed on the surface when the coating material was applied to a substrate and then dried, and an antiglare hard coat layer exhibiting the desired properties was formed by irradiating the layer with an active energy beam.

The present invention has been completed based on the knowledge.

The present invention provides:

(1) A material for forming an antiglare hard coat layer which comprises (A) a polymerizable compound of an active energy beam curing type, (B) a thermoplastic resin, (C) a good solvent for component (A) and component (B), and (D) a poor solvent for component (B), wherein a ratio of an amount by weight of component (A) to an amount by weight of component (B) is 100:0.3 to 100:50 and a ratio of an amount by weight of component (C) to an amount by weight of component (D) is 99:1 to 30:70;

(2) A material for forming an antiglare hard coat layer described in (1), wherein a boiling point of the poor solvent of component (D) is higher than a boiling point of the good solvent of component (C);

(3) A material for forming an antiglare hard coat layer described in any one of (1) and (2), wherein the thermoplastic resin of component (B) is at least one resin selected from polyester-based resins, polyester urethane-based resins and acrylic resins;

(4) A material for forming an antiglare hard coat layer described in any one of (1) to (3), which further comprises (E) at least one particles selected from the group consisting of inorganic fine particles and organic fine particles in an amount of 0.1 to 10 parts by weight per 100 parts by weight of a total of amounts of component (A) and component (B);

(5) An antiglare hard coat film which comprises a substrate and an antiglare hard coat layer which comprises a layer of an active energy beam-cured resin formed by using a material described in any one of (1) to (4) and disposed on the substrate film;

(6) An antiglare hard coat film described in (5), wherein an arithmetic average roughness Ra of a surface of the antiglare hard coat layer is 0.005 to 0.300 μm;

(7) An antiglare hard coat film described in any one of (5) and (6), which has a haze of 2% or greater;

(8) An antiglare hard coat film described in any one of (5) to (7), which has a 60° gloss of 150 or smaller;

(9) An antiglare hard coat film described in any one of (5) to (8), which has a total value of clarity of vision through of 100 or greater;

(10) An antiglare hard coat film described in any one of (5) to (9), wherein a difference in a haze before and after a Taber wear hardness test is smaller than 5%; and

(11) An antiglare hard coat film described in any one of (5) to (10), wherein the antiglare hard coat layer has a thickness of 0.5 to 20 μm.

### THE EFFECT OF THE INVENTION

In accordance with the present invention, a coating material which can form an antiglare hard coat layer containing no fine particles or a decreased amount of fine particles for providing the antiglare property and exhibiting highly fine antiglare property, stable optical properties and excellent scratch resistance, and an antiglare hard coat film obtained by using the coating material and advantageously used for various displays, can be provided.

### DETAILED DESCRIPTION OF THE INVENTION

The material for forming an antiglare hard coat layer will be described in the following.

The material for forming an antiglare hard coat layer of the present invention (hereinafter, referred to briefly as the coating material, occasionally) is a coating material comprising (A) a polymerizable compound of the active energy beam curing type, (B) a thermoplastic resin, (C) a good solvent for component (A) and component (B), and (D) a poor solvent for component (B).

The polymerizable compound of the active energy beam curing type of component (A) used in the present invention means a polymerizable compound which is crosslinked and cured by irradiation with a radiation having energy quantum among electromagnetic waves and beams of charged particles, i.e., ultraviolet light or electron beams.

Examples of the polymerizable compound of the energy beam curing type include photopolymerizable prepolymers and photo-polymerizable monomers. Compound obtained by bonding an organic compound having a polymerizable unsaturated group to fine particles of silica can also be used. The photopolymerizable prepolymer includes photopolymerizable prepolymers of the radical polymerization type and photopolymerizable prepolymers of the cationic polymerization type. Examples of the photopolymerizable prepolymers of the radical polymerization type include polyester acrylate-based photopolymerizable prepolymers, epoxy acrylate-based photopolymerizable prepolymers, urethane acrylate-based photopolymerizable prepolymers and polyol acrylate-based photopolymerizable prepolymers. The polyester acrylate-based prepolymer can be obtained, for example, by obtaining a polyester oligomer having hydroxyl groups at both ends by condensation of a polyfunctional carboxylic acid with a polyhydric alcohol, followed by esterification of the hydroxyl groups in the obtained oligomer with (meth)acrylic acid; or by obtaining an oligomer having hydroxyl groups at both ends by addition of an alkylene oxide to a polyfunctional carboxylic acid, followed by esterification of the hydroxyl groups of the obtained oligomer with (meth)acrylic acid. In the present invention, the terms (meth)acrylic acid, (meth)acrylic ester, (meth)acrylate and (meth)acryloyl each means both acrylic acid and methacryric acid, both acrylic ester and methacrylic ester, both acrylate and methacrylate, and both acryloyl and methacryloyl, respectively.

The epoxy acrylate-based prepolymer can be obtained, for example, by esterification of oxirane rings in an epoxy resin of a bisphenol type or a novolak type having a relatively low molecular weight by the reaction with (meth)acrylic acid. The urethane acrylate-based prepolymer can be obtained, for example, by obtaining a polyurethane oligomer by the reaction of a polyether polyol or a polyester polyol with a polyisocyanate, followed by esterification of the obtained oligomer with (meth)acrylic acid. The polyol acrylate-based prepolymer can be obtained, for example, by esterification of hydroxyl groups in a polyether polyol with (meth)acrylic acid. The above photopolymerizable prepolymer may be used singly or in combination of two or more.

As the photopolymerizable prepolymer of the cationic polymerization type, in general, epoxy resins are used. Examples of the epoxy resin include compounds obtained by epoxidation of polyhydric phenols such as bisphenol resins and novolak resins with epichlorohydrin and compounds obtained by oxidation of linear olefin compounds and cyclic olefin compounds with peroxides.

Examples of the photopolymerizable monomer include polyfunctional acrylates such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, neopentyl glycol hydroxypivalate di(meth)acrylate, dicyclopentanyl di(meth)acrylate, dicyclopentenyl di(meth)acrylate modified with caprolactone, di(meth)acrylate of phosphoric acid modified with ethylene oxide, cyclohexyl di(meth)acrylate substituted with allyl group, isocyanurate di(meth)acrylate, trimethylolpropane tri(meth)acrylate, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide, tris(acryloxyethyl) isocyanurate, dipentaerythritol penta(meth)acrylate modified with propionic acid, dipentaerythritol hexa(meth)acrylate and dipentaerythritol hexa(meth)acrylate modified with caprolactone. The above photopolymerizable monomers may be used singly or in combination of two or more. The photopolymerizable monomer may be used in combination with the photopolymerizable prepolymer described above.

Examples of the compound obtained by bonding an organic compound having a polymerizable unsaturated group to fine particles of silica include compounds obtained by bringing an organic compound having a polymerizable unsaturated group and a functional group reactive with hydroxyl group at the surface of the fine particles of silica (silanol group) in the molecule into reaction with the fine particles of silica. Examples of the polymerizable unsaturated group include (meth)acryloyl group. Examples of the functional group reactive with silanol group include alkoxyl groups and isocyanate group.

As the hard coat material of the ultraviolet light (UV) curing type containing the compound obtained by bonding an organic compound having a polymerizable unsaturated group to fine particles of silica, for example, commercial products such as “DeSolite Z7530” and “DeSolite Z7524” manufactured by JSR Corporation are available.

A photopolymerization initiator may be used in combination with the polymerizable compound, where desired. Examples of the photopolymerization initiator for the photopolymerizable prepolymers and the photopolymerizable monomers of the radical polymerization type include benzoin, benzoin methyl ether, benzoin ethyl ether, benzoin isopropyl ether, benzoin n-butyl ether, benzoin isobutyl ether, acetophenone, dimethylaminoacetophenone, 2,2-dimethoxy-2-phenyl-acetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propane-1-one, 4-(2-hydroxyethoxy)-phenyl 2-(hydroxy-2-propyl) ketone, benzophenone, p-phenylbenzophenone, 4,4′-diethylaminobenzophenone, dichlorobenzophenone, 2-methylanthraquinone, 2-ethylanthraquinone, 2-tertiary-butyl-anthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal and esters of p-dimethylaminobenzoic acid. Examples of the photopolymerization initiator for the photopolymerizable prepolymers of the cationic polymerization type include compounds composed of oniums such as aromatic sulfonium ions, aromatic oxosulfonium ions and aromatic iodonium ions and anions such as tetrafluoroborates, hexafluorophosphates, hexafluoroantimonates and hexafluoroarsenates. The above photopolymerization initiators may be used singly or in combination of two or more. The amount is selected, in general, in the range of 0.2 to 10 parts by weight per 100 parts by weight of the photopolymerizable prepolymer and/or the photopolymerizable monomer.

The thermoplastic resin of component (B) is not particularly limited, and various resins can be used. From the standpoint of the phase separation from the polymerizable compound of the active energy curing type of component (A) and the properties of the formed antiglare hard coat layer, polyester-based resins, polyester urethane-based resins and acrylic resins are preferable. The thermoplastic resin may be used singly or in combination of two or more.

Examples of the polyester-based resin include polymers obtained by polycondensation of at least one compound selected from alcohol components such as ethylene glycol, propylene glycol, 1,3-butanediol, 1,4-butanediol, diethylene glycol, triethylene glycol, 1,5-pentanediol, 1,6-hexanediol, neopentyl glycol, cyclohexane-1,4-dimethanol, hydrogenated bisphenol A and addition products of ethylene oxide and propylene oxide to bisphenol A with at least one compound selected from carboxylic acid components such as terephthalic acid, isophthalic acid, naphthalenedicarboxylic acid, cyclohexane-1,4-dicarboxylic acid, adipic acid, azelaic acid, maleic acid, fumaric acid, itaconic acid and anhydrides of these acids.

Examples of the polyester urethane-based resin include polymers obtained by reacting various isocyanate compounds with polyester polyols having hydroxyl group at the chain ends which are obtained by polycondensation of the above alcohol components and the above carboxylic acid components.

Examples of the acrylic resin include polymers of at least one monomer selected from alkyl esters of (meth)acrylic acid in which the alkyl group has 1 to 20 carbon atoms and copolymers of the above alkyl esters of (meth)acrylic acid with other copolymerizable monomers.

The ratio of the amount by weight of the polymerizable compound of an active energy beam curing type of component (A) to the amount by weight of the thermoplastic resin of component (B) in the coating material of the present invention is selected in the range of 100:0.3 to 100:50. When the amount of component (B) is 0.3 parts by weight or more per 100 parts by weight of component (A), the fine roughness can be formed on the surface of the formed hard coat layer in an excellent manner. When the amount of component (B) is 50 parts by weight or less per 100 parts by weight of component (A), a hard coat layer exhibiting the excellent hardness (the scratch resistance) can be formed. It is preferable that the above ratio of the amounts by weight is 100:0.5 to 100:40 and more preferably 100:1 to 100:30.

In the present invention, a mixed solvent comprising (C) a good solvent for component (A) and component (B) described above and (D) a poor solvent for component (B) described above is used as the solvent. The good solvent and the poor solvent are defined based on the solubility obtained in accordance with the following method.

To a sample in an amount corresponding to 3 g of the solid components, a solvent used for the measurement of the solubility is added in an amount such that the entire amount is adjusted at 20 g, and the resultant mixture is stirred at a temperature of 25° C. When the sample and the solvent are compatible with uniformity and transparency without changes in the viscosity, the solvent is classified as a good solvent for the sample. When the mixture shows turbidity, an increase in the viscosity or phase separation, the solvent is classified as a poor solvent for the sample.

When the thermoplastic resin of component (B) is, for example, a polyester-based resin or a polyester urethane-based resin, examples of the good solvent include toluene, methyl ethyl ketone, methyl isobutyl ketone, cyclohexanone, acetone, ethyl acetate and tetrahydrofuran, and examples of the poor solvent include xylene, ethylcellosolve, propylene glycol monomethyl ether, isobutanol, isopropanol, ethanol, methanol, hexane and purified water.

When the thermoplastic resin of component (B) is an acrylic resin, examples of the good solvent include toluene, methyl ethyl ketone, methyl isobutyl ketone, cyclohexanone, acetone, ethyl acetate, tetrahydrofuran and xylene, and examples of the poor solvent include ethylcellosolve, propylene glycol monomethyl ether, isobutanol, isopropanol, ethanol, methanol, hexane and purified water.

The above good solvents and the above poor solvents except the purified water are all good solvents for conventional polymerizable compounds of the active energy beam curing type.

In the present invention, the solvent of component (C) may be used singly or in combination of two or more, and the solvent of component (D) may be used singly or in combination of two or more.

The ratio of the amount by weight of the solvent of component (C) to the amount by weight of the solvent of component (D) in the coating material of the present invention is selected in the range of 99:1 to 30:70. When the ratio is in the above range, the excellent phase separation takes place during the formation of the hard coat layer, and the fine rough structure is formed on the surface of the obtained hard coat layer. It is preferable that the ratio of the amounts by weight is in the range of 97:3 to 40:60 and more preferably in the range of 95:5 to 60:40.

In the present invention, it is preferable for achieving more excellent phase separation during the formation of the hard coat layer and forming a more excellent fine rough structure on the surface of the obtained hard coat layer that a solvent having a higher boiling point than the solvent of component (C) is used as the solvent of component (D). The difference in the boiling points of the solvent of component (C) and the solvent of component (D) is, in general, about 10 to 100° C. and preferably 20 to 80° C.

In the coating material of the present invention, when components (A) to (D) are comprised in the above relative amounts, the fine rough structure is formed on the surface of the hard coat layer by the phase separation during the formation of the hard coat layer, and the highly fine antiglare property can be provided. Unlike conventional coating materials, it is not necessary for the coating material of the present invention that the coating material comprises inorganic fine particles or organic fine particles to exhibit the antiglare property. However, where desired, inorganic and/or organic fine particles may be added as component (E) as long as the effect of the present invention is not adversely affected.

The above inorganic fine particles and organic fine particles are not particularly limited and suitably selected from fine particles conventionally used for providing hard coat layers with the antiglare property. As the inorganic fine particles, fine particles of colloidal silica having an average particle diameter of about 10 to 100 nm are preferable. As the organic fine particles, fine particles of polymethyl methacrylate, fine particles of polycarbonates, fine particles of polystyrene, fine particles of polyacryl styrene and fine particles of polyvinyl chloride, which have an average particle diameter of about 1 to 10 μm, are preferable.

In the present invention, the inorganic fine particles and the organic fine particles may be used singly or in combination of two or more. A content remarkably smaller than the content in conventional technology is sufficient. In general, the content is about 0.1 to 10 parts by weight per 100 parts by weight of the total of the amounts of component (A) and component (B) described above. When the content of the fine particles is within the above range, the formed hard coat layer exhibits stable optical properties and is provided with the excellent antiglare property. It is preferable that the content of the above fine particles is 1 to 8 parts by weight and more preferably 2.5 to 5 parts by weight.

The content of the solvent in the coating material of the present invention is not particularly limited and can be suitably selected so that a viscosity suitable for the coating operation can be obtained.

Where desired, the coating material of the present invention may further comprise various additives such as antioxidants, ultraviolet light absorbents, photostabilizers, leveling agents and defoaming agents in combination with the above components (A) to (E) as long as the effect of the present invention is not adversely affected.

The antiglare hard coat film of the present invention will be described in the following.

The antiglare hard coat film of the present invention comprises a substrate film and an antiglare hard coat layer which comprises a layer of an active energy beam-cured resin formed by using the hard coating material of the present invention described above and is disposed on the substrate film.

The substrate film is not particularly limited and a suitable plastic film can be selected from conventional plastic films which are used as the substrate film in hard coat films for optical applications. Examples of the plastic film include films of polyesters such as polyethylene terephthalate, polybutylene terephthalate and polyethylene naphthalate, polyethylene films, polypropylene films, cellophane, diacetylcellulose films, triacetylcellulose films, acetylcellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyether sulfone films, polyether imide films, polyimide films, fluororesin films, polyamide films, acrylic resin films, norbornene-based resin films and cycloolefin resin films.

The substrate film may be transparent or translucent and may be colored or colorless. These properties can be suitably selected in accordance with the application. For example, when the hard coat film is used as a protective film of a liquid crystal display, a colorless transparent film is preferable.

The thickness of the substrate film is not particularly limited and suitably selected in accordance with the situation. The thickness is, in general, in the range of 15 to 250 μm and preferably in the range of 30 to 200 μm. One or both surfaces of the substrate film may be treated, for example, by oxidation or by a treatment of forming rough surfaces, where desired, so that adhesion with layers disposed on the surfaces is enhanced. Examples of the treatment of the surface by oxidation include the treatment by corona discharge, the treatment with chromic acid (a wet process), the treatment with flame, the treatment with heated air and the irradiation with ultraviolet light in the presence of ozone. Examples of the treatment of forming rough surfaces include the treatment by sand blasting and the treatment with a solvent. The surface treatment is suitably selected in accordance with the type of the substrate film. In general, the treatment by corona discharge is preferable from the standpoint of the effect and the operability.

The coating material of the present invention described above is applied in accordance with a conventional process such as the bar coating process, the knife coating process, the roll coating process, the blade coating process, the die coating process and the gravure coating process to form a coating layer. After the formed coating layer is dried, the hard coat layer is formed by curing the coating layer by irradiation with an active energy beam.

Examples of the active energy beam include ultraviolet light and electron beams. Ultraviolet light can be obtained from a high pressure mercury lamp, a fusion H lamp or a xenon lamp. The amount of the light used for the irradiation is, in general, in the range of 100 to 500 mJ/cm². Electron beams are obtained from an electron accelerator. The amount of the beams used for the irradiation is, in general, in the range of 150 to 350 kV. Between these active energy beams, ultraviolet light is preferable. When the electron beams are used, a cured hard coat layer can be obtained without adding a polymerization initiator.

It is preferable that the hard coat layer thus formed has a thickness in the range of 0.5 to 20 μm. When the thickness is smaller than 0.5 μm, there is the possibility that the scratch resistance of the hard coat film is not sufficiently exhibited. When the thickness exceeds 20 μm, there is the possibility that the 60° gloss increases. From the standpoint of the balance between the scratch resistance and the 60° gloss, it is more preferable that the thickness of the hard coat layer is in the range of 1 to 15 μm and most preferably in the range of 2 to 10 μm.

In the antiglare hard coat film of the present invention, the arithmetic average roughness Ra of the surface of the antiglare hard coat layer is, in general, about 0.005 to 0.300 μm. When the value of Ra is within the above range, fine dense roughness is formed, and excellent clarity of vision through is obtained. It is preferable that the value of Ra is in the range of 0.010 to 0.150 μm.

The arithmetic average roughness described above is the value obtained by the measurement in accordance with the method of Japanese Industrial Standard B 0601-1994.

It is preferable that the antiglare hard coat film of the present invention has the following optical properties and hardness so that the object of the present invention is achieved.

In the antiglare hard coat film of the present invention, the haze and the 60° gloss are indices expressing the anti-glare property. It is preferable that the haze is 2% or greater and the 60° gloss is 150 or smaller. When the haze is smaller than 2%, it is difficult that the sufficient antiglare property is exhibited. When the 60° gloss exceeds 150, the gloss of the surface is great, i.e., the reflection of light is great, and the antiglare property is adversely affected. A very great haze is not preferable since the light transmittance decreases. It is preferable that the total value of clarity of vision through is 100 or greater. The total value of clarity of vision through is the index expressing the quality of displayed images, i.e., the visibility. When this value is smaller than 100, sufficiently excellent quality of displayed images, i.e., sufficient visibility, cannot be obtained. It is preferable that the total light transmittance is 88% or greater. When the total light transmittance is smaller than 88%, there is the possibility that the transparency is insufficient.

From the standpoint of the balance among the antiglare property, the quality of displayed images, i.e., the visibility, the light transmittance and the transparency, it is more preferable that the haze is in the range of 3 to 80%, the total value of clarity of vision through is 150 or greater, and the total light transmittance is 90% or greater.

It is preferable that the difference in the haze before and after the Taber abrasion hardness test is smaller than 5% and more preferably 3% or smaller. The smaller the difference in the haze, the more resistant to scratches the surface.

The methods for the measurements of optical properties and the method of the Taber wear hardness test will be described later.

In the present invention, where necessary, an antireflection layer such as a siloxane-based coating film and a fluorine-based coating film may be formed on the surface of the hard coat layer to provide the surface with the property of preventing reflection of light. It is suitable that the antireflection layer has a thickness in the range of about 0.05 to 1 μm. Disturbance of images on the display by reflection of light from the sun or the fluorescent light can be prevented by disposing the antireflection layer. The total light transmittance can be increased and the transparency can be improved by suppressing reflection of light at the surface. The antistatic property can also be improved by suitably selecting the type of the layer for preventing reflection of light.

In the antiglare hard coat film of the present invention, an adhesive layer for sticking the hard coat film to an adherent such as a liquid crystal display may be formed on the face of the substrate film opposite to the face having the hard coat layer. As the adhesive forming the adhesive layer, adhesives for optical applications such as acrylic adhesives, urethane-based adhesives and silicone-based adhesives are preferable. The thickness of the adhesive layer is, in general, in the range of 5 to 100 μm and preferably in the range of 10 to 60 μm.

A release film may be disposed on the adhesive layer. Examples of the release film include release films prepared by coating paper such as glassine paper, coated paper and laminate paper or a plastic film with a release agent such as a silicone resin. The thickness of the release film is not particularly limited. In general, the thickness of the release film is in the range of about 20 to 150 μm.

### EXAMPLES

The present invention will be described more specifically with reference to examples in the following. However, the present invention is not limited to the examples.

The properties of an antiglare hard coat film were measured in accordance with the following methods.

(1) Total Light Transmittance and Haze

The total light transmittance and the haze were measured in accordance with the method of Japanese Industrial Standard K7136 using a haze meter manufactured by Nippon Denshoku Industries Co., Ltd.

(2) 60° Gloss

The 60° gloss was measured in accordance with the method of Japanese Industrial Standard K7105 using a gloss meter manufactured by Nippon Denshoku Industries Co., Ltd.

(3) Total Value of Clarity of Vision Through

The total value of clarity of vision through was measured in accordance with the method of Japanese Industrial Standard K7105 using an image clarity meter manufactured by SUGA TEST INSTRUMENTS Co., Ltd. The sum of the values obtained by the measurements using four types of slit was used as the total value of clarity of vision through.

(4) Taber Abrasion Hardness Test

Using a Taber abrasion hardness tester manufactured by TESTER SANGYO Co., Ltd., the haze before and after the abrasion test were measured, and the Taber hardness was expressed as ΔH. (The abrasion wheel: CS-10F; the load: 2.45 N; 100 cycles)

(5) Scratch Resistance

The surface of a coated layer of a hard coat film was rubbed with steel wool #0000, and the condition of the surface was visually observed. The result is expressed in accordance with the following criterion:

good: no scratches found

fair: the color condition of the surface changed

poor: scratches found

(6) Stability of a Coating Material

After a coating material was left standing for 24 hours, the condition of the coating material was visually observed. The result is expressed in accordance with the following criterion:

good: no change

poor: precipitation (caking) found

(7) Arithmetic Average Roughness Ra of a Surface

The arithmetic average roughness Ra of a surface was measured in accordance with the method of Japanese Industrial Standard B 601-1994 using a surface roughness meter “SV30000S4” manufactured by Mitutoyo Corporation.

### Test Example 1

To a polyester resin [manufactured by Toyobo Co., Ltd.; the trade name: “VYLON 20SS”; the content of solid components: 30% by weight] in an amount such that the amount of the solid components was 3 g, a solvent was added in an amount such that the entire amount was adjusted at 20 g, and the resultant mixture was stirred at 25° C. The condition of the mixture was visually observed.

When the components of the mixture were compatible with uniformity and transparency without changes in the viscosity, the solvent was classified as a good solvent for the above polyester resin component. Toluene, methyl ethyl ketone, methyl isobutyl ketone, cyclohexanone, acetone, ethyl acetate and tetrahydrofuran were found to be the good solvents.

When the mixture showed turbidity, an increase in the viscosity or phase separation, the solvent was classified as a poor solvent for the above polyester resin component. Xylene, ethylcellosolve, propylene glycol monomethyl ether, isobutanol, isopropanol, ethanol, methanol, hexane and purified water were found to be the poor solvents.

### Test Example 2

The same test as that conducted in Test Example 1 was conducted using a polyester urethane resin [manufactured by Toyobo Co., Ltd.; the trade name: “VYLON UR1400”; the content of solid components: 30% by weight] and a polyester urethane resin [manufactured by Toyobo Co., Ltd.; the trade name: “VYLON UR3200”; the content of solid components: 30% by weight], and the same results as those obtained in Test Example 1 were obtained.

### Test Example 3

The same test as that conducted in Test Example 1 was conducted using a hard coating material of the UV curing type [manufactured by JSR Corporation; the trade name: “DeSolite Z7530”; the content of solid components: 75% by weight] and a hard coating material of the UV curing type [manufactured by JSR Corporation; the trade name: “DeSolite Z7524”; the content of solid components: 75% by weight]. As the result, the good solvents and the poor solvents except the purified water in Test Example 1 were all found to be good solvents for the components of the hard coating material of the UV curing type.

### Example 1

A hard coating material of the UV curing type [manufactured by JSR Corporation; the trade name: “DeSolite Z7530”; a polymerizable compound of the active energy beam curing type: 70% by weight; a photopolymerization initiator: 5% by weight; methyl ethyl ketone: 25% by weight] as the polymerizable compound of the active energy beam curing type in an amount of 100 parts by weight, 7.5 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (3.2 parts by weight of the solid components per 100 parts by weight of the solid components in the polymerizable compound of the active energy beam curing type), 11.3 parts by weight of ethylcellosolve (a poor solvent for the polyester resin; the boiling point: 135.6° C.), 67.9 parts by weight of toluene (a good solvent for the hard coating material and the polyester resin; the boiling point: 110.6° C.) and 34.0 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 92.1:7.9.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high voltage mercury lamp, and an antiglare hard coat film was obtained.

The properties of the obtained antiglare hard coat film are shown in Table 1.

### Example 2

A hard coating material of the UV curing type [manufactured by JSR Corporation; the trade name: “DeSolite Z7530”] (described above) as the polymerizable compound of the active energy beam curing type in an amount of 100 parts by weight, 12.5 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (5.4 parts by weight of the solid components per 100 parts by weight of the solid components in the polymerizable compound of the active energy beam curing type), 11.2 parts by weight of ethylcellosolve (a poor solvent for the polyester resin; the boiling point: 135.6° C.), 67.5 parts by weight of toluene (a good solvent for the hard coating material and the polyester resin; the boiling point: 110.6° C.) and 33.8 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 92.4:7.6.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Example 3

A hard coating material of the UV curing type [manufactured by JSR Corporation; the trade name: “DeSolite Z7524”; a polymerizable compound of the active energy beam curing type: 70% by weight; a photopolymerization initiator: 5% by weight; methyl ethyl ketone: 25% by weight] as the polymerizable compound of the active energy beam curing type in an amount of 100 parts by weight, 25 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (10.7 parts by weight of the solid components per 100 parts by weight of the solid components in the polymerizable compound of the active energy beam curing type), 11.1 parts by weight of isobutanol (a poor solvent for the polyester resin; the boiling point: 107.9° C.), 66.4 parts by weight of methyl ethyl ketone (a good solvent for the hard coating material and the polyester resin; the boiling point: 79.6° C.) and 33.2 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 92.8:7.2.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high voltage mercury lamp, and an antiglare hard coat film was obtained.

The properties of the obtained antiglare hard coat film are shown in Table 1.

### Example 4

A hard coating material of the UV curing type [manufactured by JSR Corporation; the trade name: “DeSolite Z7524”] (described above) as the polymerizable compound of the active energy beam curing type in an amount of 100 parts by weight, 50 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (21.4 parts by weight of the solid components per 100 parts by weight of the solid components in the polymerizable compound of the active energy beam curing type), 10.7 parts by weight of propylene glycol monomethyl ether (a poor solvent for the polyester resin; the boiling point: 120° C.), 64.3 parts by weight of methyl ethyl ketone (a good solvent for the hard coating material and the polyester resin; the boiling point: 79.6° C.) and 32.1 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 93.6:6.4.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Example 5

A hard coating material of the UV curing type [manufactured by JSR Corporation; the trade name: “DeSolite Z7530”] (described above) as the polymerizable compound of the active energy beam curing type in an amount of 100 parts by weight, 7.5 parts by weight of a polyester urethane resin [manufactured by Toyobo Co., Ltd.; the trade name: “VYLON UR1400”; containing a toluene/methyl ethyl ketone solvent (a good solvent for the polyesterurethane resin); the content of solid components: 30% by weight] as the thermoplastic resin (3.2 parts by weight of the solid components per 100 parts by weight of the solid components in the polymerizable compound of the active energy beam curing type), 11.3 parts by weight of ethylcellosolve (a poor solvent for the polyesterurethane resin; the boiling point: 135.6° C.), 67.9 parts by weight of toluene (a good solvent for the hard coating material and the polyesterurethane resin; the boiling point: 110.6° C.) and 34.0 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyesterurethane resin was 92.1:7.9.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Example 6

A hard coating material of the UV curing type [manufactured by JSR Corporation; the trade name: “DeSolite Z7530”] (described above) as the polymerizable compound of the active energy beam curing type in an amount of 100 parts by weight, 5 parts by weight of a polyester urethane resin [manufactured by Toyobo Co., Ltd.; the trade name: “VYLON UR3200”; containing a toluene/methyl ethyl ketone solvent (a good solvent for the polyesterurethane resin); the content of solid components: 30% by weight] as the thermoplastic resin (2.1 parts by weight of the solid components per 100 parts by weight of the solid components in the polymerizable compound of the active energy beam curing type), 11.4 parts by weight of ethylcellosolve (a poor solvent for the polyesterurethane resin; the boiling point: 135.6° C.), 68.2 parts by weight of toluene (a good solvent for the hard coating material and the polyesterurethane resin; the boiling point: 110.6° C.) and 34.0 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyesterurethane resin was 92.0:8.0.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Example 7

A hard coating material of the UV curing type [manufactured by JSR Corporation; the trade name: “DeSolite Z7530”] (described above) as the polymerizable compound of the active energy beam curing type in an amount of 100 parts by weight, 17.5 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (7.5 parts by weight of the solid components per 100 parts by weight of the solid components in the polymerizable compound of the active energy beam curing type), 55.9 parts by weight of ethylcellosolve (a poor solvent for the polyester resin; the boiling point: 135.6° C.) and 55.9 parts by weight of toluene (a good solvent for the hard coating material and the polyester resin; the boiling point: 110.6° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 62.5:37.5.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Example 8

A hard coating material of the UV curing type [manufactured by JSR Corporation; the trade name: “DeSolite Z7530”] (described above) as the polymerizable compound of the active energy beam curing type in an amount of 100 parts by weight, 12.5 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (5.4 parts by weight of the solid components per 100 parts by weight of the solid components in the polymerizable compound of the active energy beam curing type), 7.5 parts by weight of colloidal silica dispersed in methyl ethyl ketone [manufactured by NISSAN CHEMICAL INDUSTRIES, Ltd.; the trade name: “MEK-ST-L”; the average particle diameter: 50 nm; the content of solid components: 30% by weight] (3.1 parts by weight of the solid components per 100 parts by weight of the total of the amount of solid components in the polymerizable compound of the active energy beam curing type and the amount of solid components in the polyester resin), 55.7 parts by weight of ethylcellosolve (a poor solvent for the polyester resin; the boiling point: 135.6° C.) and 55.7 parts by weight of methyl ethyl ketone (a good solvent for the hard coating material and the polyester resin; the boiling point: 79.6° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 63.0:37.0.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

When the antiglare hard coat layers of Examples 1 to 8 were observed by a digital microscope manufactured by KEYENCE CORPORATION (the trade name: “DIGITAL MICROSCOPE VHX”), the phase separation was confirmed in all the antiglare hard coat layers.

### Comparative Example 1

A hard coating material of the UV curing type [manufactured by JSR Corporation; the trade name: “DeSolite Z7530”] (described above) as the polymerizable compound of the active energy beam curing type in an amount of 100 parts by weight, 7.5 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (3.2 parts by weight of the solid components per 100 parts by weight of the solid components in the polymerizable compound of the active energy beam curing type) and 113.2 parts by weight of methyl ethyl ketone (a good solvent for the hard coating material and the polyester resin; the boiling point: 79.6° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 100:0.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Comparative Example 2

A hard coating material of the UV curing type [manufactured by JSR Corporation; the trade name: “DeSolite Z7530”] (described above) as the polymerizable compound of the active energy beam curing type in an amount of 100 parts by weight, 7.5 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (3.2 parts by weight of the solid components per 100 parts by weight of the solid components in the polymerizable compound of the active energy beam curing type) and 113.2 parts by weight of ethylcellosolve (a poor solvent for the polyester resin; the boiling point: 135.6° C.) were uniformly mixed together, and a coating fluid for antiglare hard coating (a material for forming an antiglare hard coat layer) having a concentration of solid components of 35% by weight was prepared. Dissolution of the polyester resin in the obtained coating fluid was poor, and the coating fluid could not be used for the coating. The ratio of the amount by weight of the good solvents to the amount by weight of the poor solvent for the polyester resin was 21.1:78.9.

### Comparative Example 3

A hard coating material of the UV curing type [manufactured by JSR Corporation; the trade name: “DeSolite Z7530”] (described above) as the polymerizable compound of the active energy beam curing type in an amount of 100 parts by weight, 0.125 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (0.05 parts by weight of the solid components per 100 parts by weight of the solid components in the polymerizable compound of the active energy beam curing type), 11.4 parts by weight of ethylcellosolve (a poor solvent for the polyester resin; the boiling point: 135.6° C.), 68.6 parts by weight of toluene (a good solvent for the hard coating material and the polyester resin; the boiling point: 110.6° C.) and 34.3 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 91.9:8.1.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high pressure mercury lamp, and an antiglare hard coat film was obtained.

The properties of the obtained antiglare hard coat film are shown in Table 1.

### Comparative Example 4

A hard coating material of the UV curing type [manufactured by JSR Corporation; the trade name: “DeSolite Z7530”] (described above) as the polymerizable compound of the active energy beam curing type in an amount of 100 parts by weight, 150 parts by weight of a polyester resin [manufactured by Toyobo Co., Ltd.; the trade name: “VYLON 20SS”; containing a toluene/methyl ethyl ketone solvent (a good solvent for the polyester resin); the content of solid components: 30% by weight] as the thermoplastic resin (64.3 parts by weight of the solid components per 100 parts by weight of the solid components in the polymerizable compound of the active energy beam curing type), 9.3 parts by weight of ethylcellosolve (a poor solvent for the polyester resin; the boiling point: 135.6° C.), 55.7 parts by weight of methyl ethyl ketone (a good solvent for the hard coating material and the polyester resin; the boiling point: 79.6° C.) and 27.9 parts by weight of cyclohexanone (a good solvent having a boiling point higher than that of the poor solvent; the boiling point: 155.7° C.) were uniformly mixed together, and a coating fluid for antiglare hard coating (a material for forming an antiglare hard coat layer) having a concentration of solid components of 35% by weight was prepared. The ratio of the amount by weight of the good solvents to the amount by weight of the poor solvent for the polyester resin was 95.8:4.2.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high voltage mercury lamp, and an antiglare hard coat film was obtained.

The properties of the obtained antiglare hard coat film are shown in Table 1.

### Comparative Example 5

A hard coating material of the UV curing type [manufactured by JSR Corporation; the trade name: “DeSolite Z7530”] (described above) as the polymerizable compound of the active energy beam curing type in an amount of 100 parts by weight, 3.75 parts by weight of fine particles of silica [manufactured by FUJI SILYSIA CHEMICAL LTD.; the trade name: “Sylysia 450”; the average particle diameter: 8 μm] (5.4 parts by weight per 100 parts by weight of the solid components in the polymerizable compound of the active energy beam curing type), 60.6 parts by weight of ethylcellosolve and 60.6 parts by weight of isobutanol were uniformly mixed together, and a coating fluid for antiglare hard coating (a material for forming an antiglare hard coat layer) having a concentration of solid components of 35% by weight was prepared.

The coating fluid prepared above was applied to the surface of a polyethylene terephthalate film having a thickness of 188 μm [manufactured by Toyobo Co., Ltd.; “A4300”] using a Meyer bar in an amount such that the thickness of the cured coating layer was 3 μm. After the obtained coating layer was dried in an oven at 80° C. for 1 minute, the coating layer was irradiated with ultraviolet light of 300 mJ/cm² using a high voltage mercury lamp, and an antiglare hard coat film was obtained.

The properties of the obtained antiglare hard coat film are shown in Table 1.

TABLE 1-1

| | | Total light | | Clarity of |
|---|---|---|---|---|
| | Haze | transmittance | | vision through |
| | (%) | (%) | 60° Gloss | (total) |
| Example 1 | 7.50 | 90.63 | 78.8 | 348.1 |
| Example 2 | 10.54 | 90.47 | 63.2 | 285.5 |
| Example 3 | 27.50 | 90.93 | 46.2 | 264.4 |
| Example 4 | 32.67 | 90.89 | 46.5 | 225.9 |
| Example 5 | 22.29 | 91.29 | 69.0 | 252.2 |
| Example 6 | 73.54 | 97.92 | 9.0 | 321.2 |
| Example 7 | 42.78 | 90.41 | 23.5 | 171.4 |
| Example 8 | 29.17 | 89.99 | 21.4 | 190.1 |
| Comparative | 1.92 | 91.66 | 168.4 | 385.3 |
| Example 1 | | | | |
| Comparative | coating not possible due to poor dissolution | | | |
| Example 2 | | | | |
| Comparative | 0.49 | 91.52 | 172.7 | 385.7 |
| Example 3 | | | | |
| Comparative | 53.91 | 93.36 | 25.7 | 51.3 |
| Example 4 | | | | |
| Comparative | 32.86 | 91.58 | 48.1 | 39.8 |
| Example 5 | | | | |

TABLE 1-2

| | | | Arithmetic | |
|---|---|---|---|---|
| | | | average | |
| | Taber | | roughness of | Stability |
| | hardness | Scratch | surface Ra | of coating |
| | [ΔH] | resistance | (μm) | material |
| Example 1 | 0.84 | good | 0.026 | good |
| Example 2 | 0.60 | good | 0.041 | good |
| Example 3 | 0.91 | good | 0.049 | good |
| Example 4 | 1.41 | good | 0.066 | good |
| Example 5 | 0.75 | good | 0.039 | good |
| Example 6 | 1.87 | good | 0.032 | good |
| Example 7 | 0.98 | good | 0.072 | good |
| Example 8 | 1.67 | good | 0.084 | good |
| Comparative | 1.55 | good | 0.004 | good |
| Example 1 | | | | |
| Comparative | coating not possible due to poor dissolution | | | |
| Example 2 | | | | |
| Comparative | 1.56 | good | 0.002 | good |
| Example 3 | | | | |
| Comparative | 7.20 | poor | 0.486 | good |
| Example 4 | | | | |
| Comparative | 6.47 | fair | 0.527 | poor |
| Example 5 | | | | |

What is claimed is:

1. A material for forming an antiglare hard coat layer which comprises (A) a polymerizable compound of an active energy beam curing type, (B) a thermoplastic resin, (C) a good solvent for component (A) and component (B), and (D) a poor solvent for component (B), wherein a ratio of an amount by weight of component (A) to an amount by weight of component (B) is 100:0.3 to 100:50 and a ratio of an amount by weight of component (C) to an amount by weight of component (D) is 99:1 to 30:70.

2. A material for forming an antiglare hard coat layer according to claim 1, wherein a boiling point of the poor solvent of component (D) is higher than a boiling point of the good solvent of component (C).

3. A material for forming an antiglare hard coat layer according to claim 1, wherein the thermoplastic resin of component (B) is at least one resin selected from polyester-based resins, polyester urethane-based resins and acrylic resins.

4. A material for forming an antiglare hard coat layer according to claim 2, wherein the thermoplastic resin of component (B) is at least one resin selected from polyester-based resins, polyester urethane-based resins and acrylic resins.

5. A material for forming an antiglare hard coat layer according to claim 1, which further comprises (E) at least one particles selected from the group consisting of inorganic fine particles and organic fine particles in an amount of 0.1 to 10 parts by weight per 100 parts by weight of a total of amounts of component (A) and component (B).

6. An antiglare hard coat film which comprises a substrate and an antiglare hard coat layer which comprises a layer of an active energy beam-cured resin formed by using a material described in claim 1 and is disposed on the substrate film.

7. An antiglare hard coat film which comprises a substrate and an antiglare hard coat layer which comprises a layer of an active energy beam-cured resin formed by using a material described in claim 2 and is disposed on the substrate film.

8. An antiglare hard coat film which comprises a substrate and an antiglare hard coat layer which comprises a layer of an active energy beam-cured resin formed by using a material described in claim 3 and is disposed on the substrate film.

9. An antiglare hard coat film which comprises a substrate and an antiglare hard coat layer which comprises a layer of an active energy beam-cured resin formed by using a material described in claim 4 and is disposed on the substrate film.

10. An antiglare hard coat film which comprises a substrate and an antiglare hard coat layer which comprises a layer of an active energy beam-cured resin formed by using a material described in claim 5 and is disposed on the substrate film.

11. An antiglare hard coat film according to claim 6, wherein an arithmetic average roughness Ra of a surface of the antiglare hard coat layer is 0.005 to 0.300 μm.

12. An antiglare hard coat film according to claim 7, wherein an arithmetic average roughness Ra of a surface of the antiglare hard coat layer is 0.005 to 0.300 μm.

13. An antiglare hard coat film according to claim 8, wherein an arithmetic average roughness Ra of a surface of the antiglare hard coat layer is 0.005 to 0.300 μm.

14. An antiglare hard coat film according to claim 9, wherein an arithmetic average roughness Ra of a surface of the antiglare hard coat layer is 0.005 to 0.300 μm.

15. An antiglare hard coat film according to claim 10, wherein an arithmetic average roughness Ra of a surface of the antiglare hard coat layer is 0.005 to 0.300 μm.

16. An antiglare hard coat film according to claim 6, which has a haze of 2% or greater.

17. An antiglare hard coat film according to claim 6, which has a 60° gloss of 150 or smaller.

18. An antiglare hard coat film according to claim 6, which has a total value of clarity of vision through of 100 or greater.

19. An antiglare hard coat film according to claim 6, wherein a difference in a haze before and after a Taber abrasion hardness test is smaller than 5%.

20. An antiglare hard coat film according to claim 6, wherein the antiglare hard coat layer has a thickness of 0.5 to 20 μm.
